(19) United States
(12) Patent Application Publication
(10) Pub. No.: US 2023/0421506 A1
(43) Pub. Date: Dec. 28, 2023

(54) AUTOMATIC CONNECTION CONTROLLER, AUTOMATIC CONNECTION CONTROL METHOD, AUTOMATIC CONNECTION CONTROL PROGRAM AND AUTOMATIC CONNECTION CONTROL SYSTEM

(71) Applicant: NIPPON TELEGRAPH AND TELEPHONE CORPORATION, Tokyo (JP)

(72) Inventors: Takamitsu TOCHINO, Musashino-shi, Tokyo (JP); Hirotaka UJIKAWA, Musashino-shi, Tokyo (JP); Yoshihito SAKAI, Musashino-shi, Tokyo (JP)

(73) Assignee: NIPPON TELEGRAPH AND TELEPHONE CORPORATION, Tokyo (JP)

(21) Appl. No.: 18/037,078

(22) PCT Filed: Nov. 25, 2020
(86) PCT No.: PCT/JP2020/043828

§ 371 Date: May 15, 2023

(51) Int. Cl. H04L 47/26; H04Q 11/00; H04L 43/0882; H04L 47/11

(52) U.S. Cl. CPC H04L 47/266; H04Q 11/0067; H04L 43/0882; H04L 47/11; H04Q 2011/0086

(57) ABSTRACT

A user terminal 12-1 can wirelessly or preferentially connect to a router 14 to communicate with an upper network 18, and can communicate with another network 20 via a mobile line. An ONU 16 generates a disconnection notification in a case where congestion exceeding a reference is recognized in the PON communicating with the upper network 18, and generates a connection notification when the congestion is resolved. The router 14 stores the user terminal 12-1 that can communicate with another network 20 among the user terminals 12-1 to 12-4 being connected. In addition, the router 14 disconnects the connection with the user terminal 12-1 that can communicate with another network 20 when the disconnection notification is generated, and attempts reconnection with the user terminal 12-1 that has been disconnected when the connection notification is generated.

### TECHNICAL FIELD

The present disclosure relates to an automatic connection control device, an automatic connection control method, an automatic connection control program, and an automatic connection control system, and more particularly, to an automatic connection control device, an automatic connection control method, an automatic connection control program, and an automatic connection control system for controlling a connection state of a user terminal having a function of connecting to an external network by selectively using two paths.

### BACKGROUND ART

FIG. 1 illustrates an example of a communication system 10. The example illustrated in FIG. 1 includes a plurality of user terminals 12-1 to 12-4. These user terminals 12-1 to 12-4 can communicate with a router 14 by Ethernet (registered trademark) or WiFi (registered trademark). The router 14 is connected to an optical network unit (ONU) 16. The ONU 16 constitutes a part of a passive optical network (PON), and is connected to the upper network 18 via an optical line terminal (OLT) (not illustrated). On the other hand, it is assumed that the user terminal 12-1 can also communicate with another network 20 different from the upper network 18 via a mobile line, for example.

The example illustrated in FIG. 1 is realized when the user terminal 12-1 having a mobile communication function is brought into a building in which a fiber to the building (FTTB) service has been introduced. Further, details of the technology related to Ethernet (registered trademark) are disclosed in, for example, Non Patent Literature 1 below.

### CITATION LIST

### Non Patent Literature

Non Patent Literature 1: IEEE 802.3 Ethernet SECTION FIVE

### SUMMARY OF INVENTION

### Technical Problem

According to the technology in the related art described in Non Patent Literature 1 or the like, the user terminal 12-1 cannot ascertain the communication state between the router 14 and the upper network 18. Therefore, even when communication via the router 14 is mixed, the user terminal 12-1 may maintain communication with the router 14 even though communication with another network 20 is possible.

Under such a situation, when the user terminal 12-1 switches the communication destination from the router 14 to another network 20, there is a possibility that the communication efficiency of the user terminal 12-1 itself will be improved, and at the same time, the communication efficiency of the other user terminals 12-2 to 12-4 will also be improved.

The invention according to the present disclosure has been made in view of the above points, and a first object thereof is to provide an automatic connection control device having a function of prompting a user terminal capable of performing communication through a plurality of paths to switch to another path in a case where communication through one path is congested.

In addition, a second object of the invention according to the present disclosure is to provide an automatic connection control method for prompting a user terminal capable of performing communication through a plurality of paths to switch to another path in a case where communication through one path is congested.

In addition, a third object of the present disclosure is to provide an automatic connection control program for prompting a user terminal capable of performing communication through a plurality of paths to switch to another path in a case where communication through one path is congested.

In addition, a fourth object of the present disclosure is to provide an automatic connection control system for prompting a user terminal capable of performing communication through a plurality of paths to switch to another path in a case where communication through one path is congested.

### Solution to Problem

According to a first aspect, in order achieve the above object, it is desirable that there be provided an automatic connection control device connected to an upper network via a communication line and having a function of establishing connection with a user terminal in a wired or wireless manner, the automatic connection control device including: a connection monitoring unit that monitors a connection state with the user terminal; a network information storage unit that stores information indicating whether or not the user terminal being connected has a function of establishing communication with another network different from the upper network; and a connection control unit that controls connection with the user terminal, in which the connection control unit executes a process of detecting that congestion exceeding a determination criterion is occurring in the communication line communicating with the upper network, a disconnection process of disconnecting connection from the user terminal having a function of establishing communication with the another network among the user terminals being connected in a case where congestion is recognized, a process of detecting resolution of the congestion, and a process of enabling reconnection to the user terminal of which connection has been disconnected by the disconnection process in a case where resolution of the congestion is recognized.

Further, according to a second aspect, it is desirable that there be provided an automatic connection control method for controlling connection between a communication line connected to an upper network and a user terminal, the automatic connection control method including: a step of storing information indicating whether or not the user terminal being connected to the communication line has a function of establishing communication with another network different from the upper network; a congestion calculation step of calculating a congestion degree of the communication line communicating with the upper network; a congestion determination step of determining congestion of the communication line in a case where the congestion degree exceeds a determination criterion; a disconnection step of disconnecting connection between the user terminal having a function of establishing communication with the another network among the user terminals being connected to the communication line and the communication line in a case where the congestion is recognized; a resolution determination step of determining that the congestion has been resolved; and a step of reconnecting the user terminal of which connection has been disconnected by a process of the disconnection step to the communication line in a case where resolution of the congestion is recognized.

Further, according to a third aspect, it is desirable that there be provided an automatic connection control program for controlling connection between a communication line connected to an upper network and a user terminal, the automatic connection control program including: a program that causes a processor that controls connection between the communication line and the user terminal to execute a connection monitoring process of monitoring a connection state between the communication line and the user terminal, a network information storing process of storing information indicating whether or not the user terminal being connected to the communication line has a function of establishing communication with another network different from the upper network, and a connection control process of controlling connection between the communication line and the user terminal, in which the connection control process includes a process of detecting that congestion exceeding a determination criterion is occurring in the communication line communicating with the upper network, a disconnection process of disconnecting connection from the user terminal having a function of establishing communication with the another network among the user terminals being connected in a case where congestion is recognized, a process of detecting resolution of the congestion, and a process of enabling reconnection to the user terminal of which connection has been disconnected by the disconnection process in a case where resolution of the congestion is recognized.

Further, according to a fourth aspect, it is desirable that there be provided an automatic connection control system for controlling connection between a communication line connected to an upper network and a user terminal, the automatic connection control system including: a router that establishes a connection to the user terminal in a wired or wireless manner; and a communication control device that establishes communication between the communication line and the router, in which the communication control device includes a connection control notification unit that calculates a congestion degree of the communication line communicating with the upper network, determines congestion of the communication line and generates a disconnection notification in a case where the congestion degree exceeds a determination criterion, and generates a connection notification in a case where resolution of the congestion is recognized based on the congestion degree, and the router includes a network information storage unit that stores information indicating whether or not a user terminal being connected to the communication line has a function of establishing communication with another network different from the upper network, a connection monitoring unit that monitors a connection state with the user terminal, and a connection control unit that receives the disconnection notification and disconnects connection to the user terminal having a function of establishing communication with the another network among the user terminals being connected to the router, and receives the connection notification and enables reconnection to the user terminal of which connection has been disconnected after receiving the disconnection notification.

### Advantageous Effects of Invention

According to the first to fourth aspects, in a case where congestion of the communication line communicating with the upper network is detected, the connection between the user terminal that can be connected to another network and the communication line thereof is disconnected. As a result, the communication load of the communication line decreases, and congestion is alleviated. On the other hand, the user terminal of which connection is disconnected can continue communication through another network. Furthermore, according to the first to fourth aspects, when the congestion of the communication line communicating with the upper network is resolved, the user terminal of which connection has been disconnected and the communication line thereof are connected again. Accordingly, efficient use of the communication line is achieved.

### BRIEF DESCRIPTION OF DRAWINGS

FIG. 1 is a diagram for explaining a basic configuration of a communication system according to Embodiment 1 of the present disclosure.

FIG. 2 is a block diagram for explaining a configuration of a router and an ONU included in the communication system according to Embodiment 1 of the present disclosure.

FIG. 3 is a flowchart for explaining a processing flow executed in the ONU illustrated in FIG. 2.

FIG. 4 is a flowchart for explaining a processing flow executed in the router illustrated in FIG. 2.

FIG. 5 is a diagram for explaining a basic configuration of a communication system according to Embodiment 2 of the present disclosure.

FIG. 6 is a block diagram for explaining a configuration of a router and an L2SW included in the communication system according to Embodiment 2 of the present disclosure.

### DESCRIPTION OF EMBODIMENTS

### Embodiment 1

### Configuration of Embodiment 1

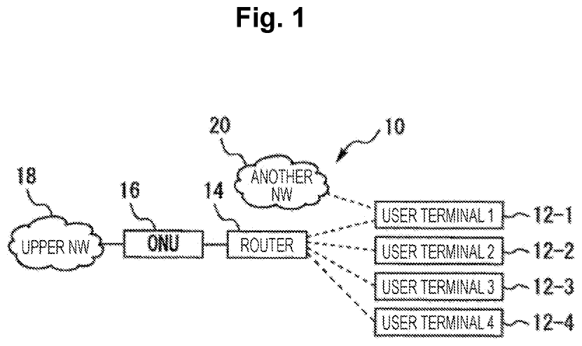

FIG. 1 is a diagram illustrating a basic configuration of a communication system 10 according to Embodiment 1 of the present disclosure. The communication system 10 illustrated in FIG. 1 includes a router 14 and an optical network unit (ONU) 16. The router 14 can establish communication with a plurality of user terminals 12-1 to 12-4 via a wired or wireless line. The router 14 can establish communication with the ONU 16 by an electrical signal.

The ONU 16 is an optical line termination device on one end side of a passive optical network (PON), and communicates with an upper network 18 via a splitter (not illustrated) and an optical line terminal (OLT). Furthermore, the OLT is an optical line termination device on the other end side of the PON. The ONU 16 and the OLT are connected by an optical fiber, and communication by an optical signal is performed therebetween.

In the configuration illustrated in FIG. 1, the user terminal 12-1 has a function of communicating with the router 14 via Ethernet (registered trademark) or WiFi (registered trademark), and a function of communicating with another network 20 via a mobile line or the like. On the other hand, the other user terminals 12-2 to 12-4 have only the function of communicating with the router 14.

### Features of Embodiment 1

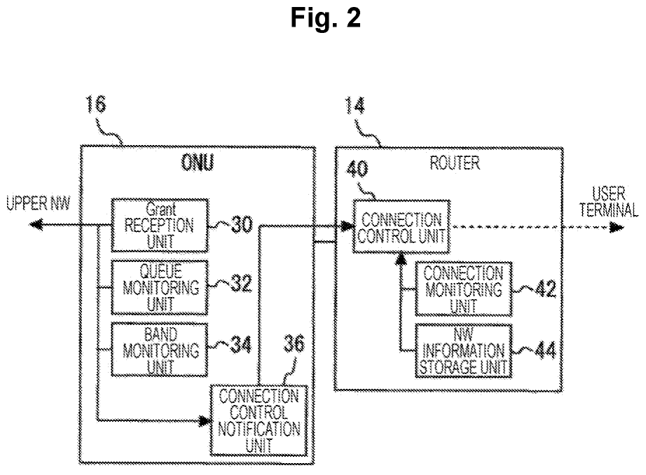

FIG. 2 is a block diagram for explaining a detailed configuration of the router 14 and the ONU 16 illustrated in FIG. 1. Each of the router 14 and the ONU 16 includes a computer having a processor and a memory. The processor may also be referred to as a central processing unit (CPU), a processing device, an arithmetic device, a microprocessor, a microcomputer, or a DSP. The memory is realized by, for example, a nonvolatile or volatile semiconductor memory such as a RAM, a ROM, a flash memory, an EPROM, or an EEPROM, or a disk type memory such as a magnetic disk, a flexible disk, an optical disc, a compact disc, a mini disc, or a DVD. Each of the router 14 and the ONU 16 realizes a desired function by causing the processor to perform processing in accordance with a program stored in the memory.

As illustrated in FIG. 2, the ONU 16 includes a Grant reception unit 30. The Grant reception unit 30 receives Grant information from the OLT (not illustrated). The PON configuration generally includes the OLT, the splitter connected to the OLT, and the plurality of ONUs connected to the splitter. The ONU 16 illustrated in FIGS. 1 and 2 is one of the plurality of ONUs. Downlink data transmitted from the OLT toward the splitter reaches all ONUs connected to the splitter. Each ONU receives only data addressed to itself and discards others'. On the other hand, uplink data emitted from the ONU toward the OLT is transmitted by a time division multiplexing (TDM) method. The Grant information is information provided from the OLT to each ONU in order to realize the TDM, and includes information such as a transmission start time and a transmission duration.

The ONU 16 also includes a queue monitoring unit 32 and a band monitoring unit 34. The queue monitoring unit 32 first monitors a queue length L of the ONU 16. The queue length L is an amount of uplink data that can be accumulated by the ONU 16. The queue monitoring unit 32 further monitors the amount of traffic queuing in the ONU 16. Since this traffic amount is provided to the OLT as a report value R in order to determine band allocation by the TDM, the traffic amount is referred to as a “report value R” in the following description. The band monitoring unit 34 monitors a communication band between the ONU 16 and the router 14.

The ONU 16 further includes a connection control notification unit 36. The connection control notification unit 36 calculates an allocation value G from the Grant information received by the Grant reception unit 30. The allocation value G corresponds to the amount of uplink data that can be transmitted by the ONU 16 by the band allocated to the ONU 16 in the current processing cycle.

The connection control notification unit 36 further calculates the data amount that can be queued after the band allocation of the current cycle, that is, the queuing margin remaining in the ONU 16 after the current processing cycle, by the following arithmetic expression using the queue length L provided from the queue monitoring unit 32 and the report value R.

Queuing margin=L−(R−G) (1)

In the above expression (1), (R−G) is an amount obtained by subtracting the data amount (G) transmitted in the current processing cycle from the data amount (R) queued at the beginning of the current processing cycle, and means the remaining amount of uplink data at the end stage of the processing cycle. Then, when the remaining amount (R−G) is subtracted from the queue length L which is the accumulation capacity of the uplink data, the queuing margin remaining at the end stage of the processing cycle is obtained.

The connection control notification unit 36 further determines whether or not the queuing margin is a sufficient value. When the queuing margin is sufficiently secured, it can be determined that data congestion does not occur in communication data via the ONU 16. In this case, the connection control notification unit 36 generates a connection notification for recognizing connection of the user terminal. On the other hand, in a case where the queuing margin is not sufficiently secured, it can be determined that data congestion has occurred in the ONU 16. In this case, the connection control notification unit 36 generates a disconnection notification for reducing the number of connections of the user terminal connected to the router 14 in order to reduce the data amount via the PON.

The above notification generated by the connection control notification unit 36 of the ONU 16 is provided to the connection control unit 40 of the router 14. The router 14 includes a connection monitoring unit 42 and a network information storage unit 44 in addition to the connection control unit 40.

The connection monitoring unit 42 monitors the state of the user terminal connected to the router 14 and provides the connection control unit 40 with information on the user terminal in communication with the router 14. The network information storage unit 44 stores whether or not the user terminal connected to the router 14 can be connected to another network 20, and provides the connection control unit 40 with the information. The fact that the user terminal can be connected to another network 20 may cause the router 14 to have a detection function, or may be registered by the user himself or herself.

When receiving the disconnection notification from the connection control notification unit 36 of the ONU 16, the connection control unit 40 disconnects the connection with a user terminal that can be connected to another network 20 among the user terminals connected to the router 14. Further, when receiving the connection notification from the connection control notification unit 36, the connection control unit 40 reconnects to the user terminal to which the connection is disconnected by the disconnection notification. As described above, according to the configuration of the present embodiment, it is possible to automatically control the connection destination of the user terminal that can be connected to another network 20 according to the congestion degree of the PON without requiring a special function for the user terminal.

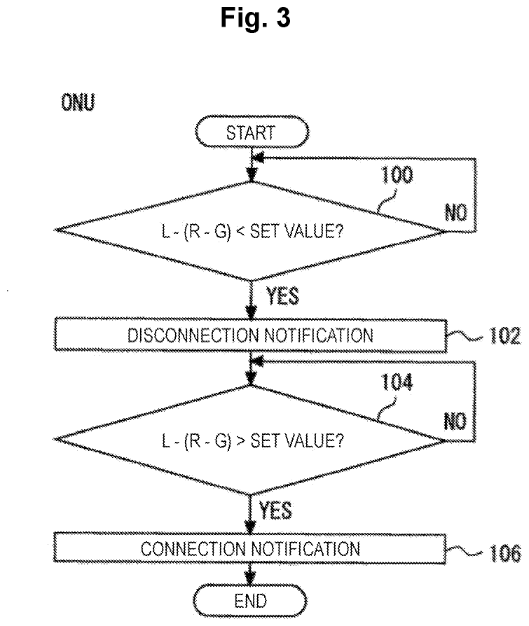

FIG. 3 is a flowchart for explaining a processing flow executed by the ONU 16 to realize the above functions. In the routine illustrated in FIG. 3, first, it is determined whether or not the queuing margin L−(R−G) calculated by the above expression (1) is smaller than the set value (step 100). This set value is a value determined in advance for determining whether or not the queuing margin is sufficient for continuing the current communication in the PON.

In a case where it is determined by the above processing that L−(R−G)<the set value is not established, it can be determined that the queuing margin is sufficiently present. In this case, since it is not necessary to change the current communication state, the processing in step 100 is repeated again without performing special processing.

On the other hand, in a case where it is recognized by the above processing that L−(R−G)<the set value is established, it can be determined that the queuing margin is insufficient to continue the current communication. In this case, a “disconnection notification” is generated to reduce the number of user terminals communicating with the router 14 (step 102). This notification is provided from the ONU 16 to the router 14 as described above.

After generating the “disconnection notification” by the above processing, the ONU 16 next determines whether or not the queuing margin is larger than the above set value (step 104). While L−(R−G)>the set value is not established, congestion of PON has not yet been resolved, and it can be determined that the number of user terminals communicating with the router 14 should not be increased. In this case, the processing of step 104 is repeated without changing the current communication state.

On the other hand, in a case where it is recognized by the above processing that L−(R−G)>the set value is established, it can be determined that the mixture of PON is eliminated since the queuing margin is sufficient. In this case, since it is possible to increase the number of user terminals communicating with the router 14, a “connection notification” is generated (step 106). This notification is also provided from the ONU 16 to the router 14 as described above.

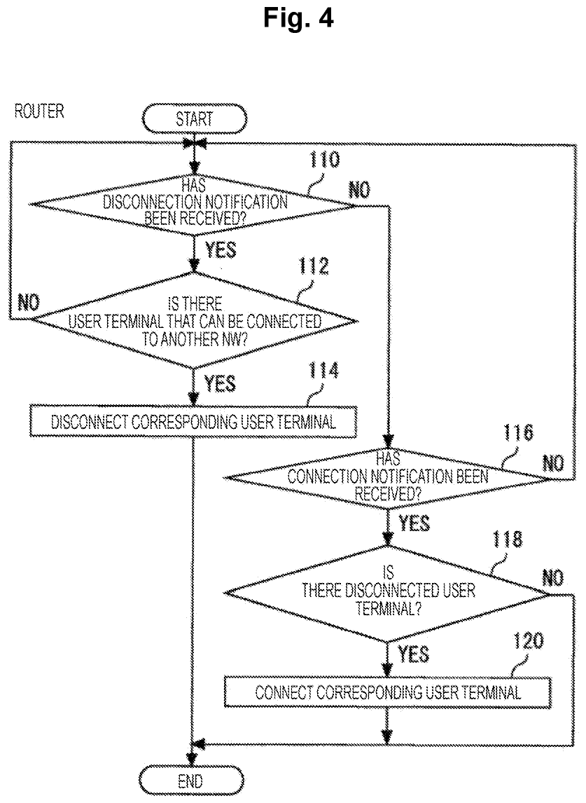

FIG. 4 is a flowchart for explaining a processing flow executed by the router 14 in the present embodiment. In the routine illustrated in FIG. 4, first, it is determined whether the “disconnection notification” has been received from the ONU 16 (step 110).

As a result, in a case where reception of the “disconnection notification” is recognized, next, it is determined whether or not there is a user terminal that can be connected to another network 20 among the user terminals that are communicating with the router 14 (step 112). This determination is made based on information stored in the network information storage unit 44. As a result, in a case where it is determined that there is no user terminal that can be connected to another network 20, since there is no user terminal of which connection is disconnected, the processing of step 110 is executed again without performing special processing thereafter.

On the other hand, in a case where it is recognized by the above processing that there is the user terminal that can be connected to another network 20, the connection to the user terminal is disconnected (step 114). Information on the user terminal of which connection has been disconnected is recorded in the connection monitoring unit 42.

For example, under the situation illustrated in FIG. 1, the router 14 disconnects the connection with the user terminal 12-1 while maintaining the connection with the user terminals 12-2 to 12-4, and stores information of the disconnection. In this case, the user terminal disconnected from the router 14 automatically establishes connection with another network 20 that is another connection destination. As a result, the load of communication via the router 14 and the PON is reduced without stopping the communication of all the user terminals 12-1 to 12-4.

In the routine illustrated in FIG. 4, in a case where it is determined in step 110 that the “disconnection notification” is not received, next, it is determined whether or not the “connection notification” has been received from the ONU 16 (step 116).

As a result, in a case where reception of the “connection notification” is not recognized, it is not necessary to change the communication state, and thus the processing of step 110 is repeated again. On the other hand, in a case where the reception of the “connection notification” is recognized, it is determined whether or not there is a user terminal in a state where the connection is disconnected by the “disconnection notification” (step 118). As a result, in a case where it is determined that there is no user terminal in the disconnected state, there is no target to be reconnected, and thus the routine of this time is terminated without performing special processing thereafter.

On the other hand, in a case where it is determined by the above processing that there is a user terminal in a disconnected state, reconnection to the user terminal is attempted (step 120). For example, in a case where the connection with the user terminal 12-1 is disconnected under the situation illustrated in FIG. 1, processing of recognizing the connection with the user terminal 12-1 is performed. As a result, the user terminal 12-1 automatically re-establishes the connection with the router 14. As a result, the communication capacity of the PON can be efficiently utilized.

### Modification of Embodiment 1

Meanwhile, in Embodiment 1 described above, the report value R represents the data amount queued at the beginning of the processing cycle, but the value R may be replaced with the data amount flowing into the ONU 16 every DBA cycle. In this case, the queuing margin used in steps 100 and 104 above is calculated by the following arithmetic expression. Here, Σ means to integrate (R−G) calculated for each DBA cycle.

Queuing margin=L−Σ(R−G) (2)

For example, in a case where the report value R of the cycle 1, that is, the data amount flowing into the ONU 16 is “5”, the allocation value G is “4”, and R of the cycle 2 is “6”, and G is “4”, Σ(R−G) up to the cycle 2 is as follows.

Σ(R−G)=(5−4)+(6−4)=3

As a result,L−Σ(R−G) becomes a value correctly representing the queuing margin remaining after the DBA cycle.

Further, in Embodiment 1 described above, the set value used in step 100 and the set value used in step 104 are set to the same value, but the present disclosure is not limited thereto. For example, the set value used in step 104 may be made larger than the set value used in step 100, and hysteresis may be given to the generation criterion of the disconnection notification and the generation criterion of the connection notification.

### Embodiment 2

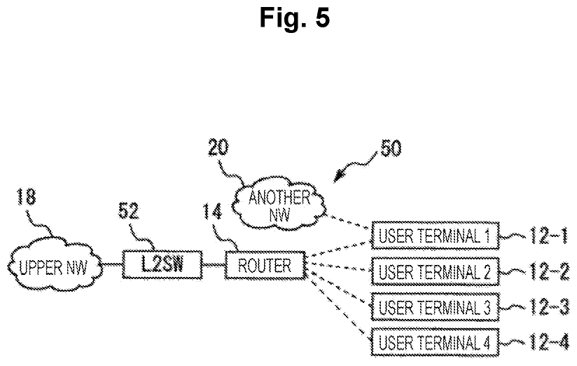

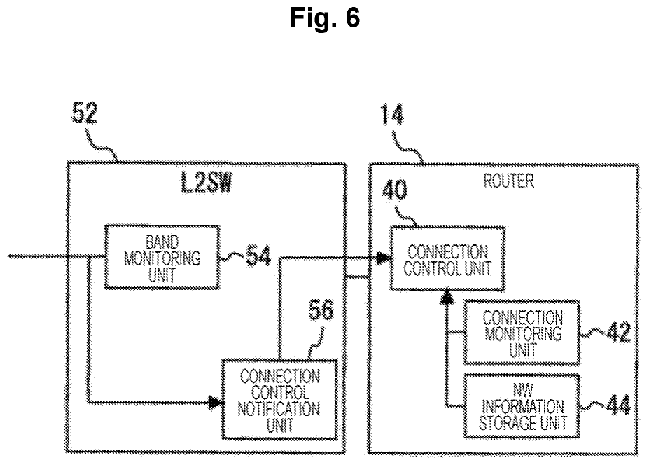

Next, Embodiment 2 of the present disclosure will be described with reference to FIGS. 5 and 6.

FIG. 5 is a diagram for explaining a configuration of a communication system 50 of the present embodiment. Note that, in FIG. 5, the same elements as those illustrated in FIG. 1 are denoted by the same reference numerals, and the description thereof will be omitted or simplified.

As illustrated in FIG. 5, the communication system 50 according to the present embodiment includes an L2SW 52 as a device that enables communication between the router 14 and the upper network 18. The communication system 50 is substantially similar to communication system 50 of Embodiment 1 except that the PON is replaced with a communication line including the L2SW 52.

FIG. 6 is a diagram for explaining a detailed configuration of the L2SW 52 and the router 14 illustrated in FIG. 5. Note that, in FIG. 6, the same elements as those illustrated in FIG. 2 are denoted by the same reference numerals, and the description thereof will be omitted or simplified.

As illustrated in FIG. 6, the L2SW 52 includes a band monitoring unit 54 and a connection control notification unit 56. The band monitoring unit 54 monitors the band utilization efficiency between the L2SW 52 and the upper network 18 and provides the result to the connection control notification unit 56.

Similarly to the connection control notification unit 36 according to Embodiment 1, the connection control notification unit 56 has a function of generating the “disconnection notification” when congestion of a line is detected, and generating a “connection notification” when resolution of the congestion is detected. Specifically, the connection control notification unit 56 generates the “disconnection notification” when the communication capacity margin between the L2SW 52 and the upper network 18 is less than the set value, and generates the “connection notification” when the communication capacity margin exceeds the set value.

In the present embodiment, a value of approximately 10% of the communication capacity of the communication line can be used as the set value. For example, in a case where the communication line connecting the L2SW 52 and the upper network 18 has a speed of 1 GbE, the set value may be 100 Mbps. In this case, the connection control notification unit 36 generates the “disconnection notification” when the band monitoring unit 54 detects a communication amount exceeding 900 Mbps, and generates the “connection notification” when the communication amount is less than 900 Mbps.

The router 14 receives the “disconnection notification” and the “connection notification” generated by the ONU 54 and operates similarly to the case of Embodiment 1. As a result, similarly to the case of Embodiment 1, the communication system 50 according to the present embodiment can automatically control the connection state between router 14 and the user terminal in accordance with the congestion degree between upper network 18 and the router 14.

### Modification of Embodiment 2

Incidentally, in Embodiment 2 described above, the set value used for determination of the “disconnection notification” and the set value used for determination of the “connection notification” are the same value, but the present disclosure is not limited thereto. The set values may be different from each other similarly to the modification example of Embodiment 1.

### REFERENCE SIGNS LIST

10, 50 Communication system
12-1 to 12-4 User terminal
14 Router
16 ONU (optical network unit)
18 Upper network
20 Another network
30 Grant reception unit
32 Queue monitoring unit
34, 54 Band monitoring unit
36, 56 Connection control notification unit
40 Connection control unit
42 Connection monitoring unit
44 Network information storage unit
52 L2SW

1. An automatic connection control device connected to an upper network via a communication line and having a function of establishing connection with a user terminal in a wired or wireless manner, the automatic connection control device comprising:
a connection monitoring unit that monitors a connection state with the user terminal;
a network information storage unit that stores information indicating whether or not the user terminal being connected has a function of establishing communication with another network different from the upper network; and
a connection control unit that controls connection with the user terminal, wherein
the connection control unit executes
a process of detecting that congestion exceeding a determination criterion is occurring in the communication line communicating with the upper network,
a disconnection process of disconnecting connection from the user terminal having a function of establishing communication with the another network among the user terminals being connected in a case where congestion is recognized,
a process of detecting resolution of the congestion, and
a process of enabling reconnection to the user terminal of which connection has been disconnected by the disconnection process in a case where resolution of the congestion is recognized.

2. An automatic connection control method for controlling connection between a communication line connected to an upper network and a user terminal, the automatic connection control method comprising:
a step of storing information indicating whether or not the user terminal being connected to the communication line has a function of establishing communication with another network different from the upper network;
a congestion calculation step of calculating a congestion degree of the communication line communicating with the upper network;
a congestion determination step of determining congestion of the communication line in a case where the congestion degree exceeds a determination criterion;
a disconnection step of disconnecting connection between the user terminal having a function of establishing communication with another network among the user terminals being connected to the communication line and the communication line in a case where the congestion is recognized;
a resolution determination step of determining that the congestion has been resolved; and
a step of reconnecting the user terminal of which connection has been disconnected by a process of the disconnection step to the communication line in a case where resolution of the congestion is recognized.

3. The automatic connection control method according to claim 2, wherein
the communication line is a PON including an ONU,
the congestion calculation step includes
a process of acquiring a queue length L of the ONU,
a process of acquiring a report value R indicating a data amount queued in the ONU,
a process of acquiring an allocation value G representing a data transmission amount allocated to the ONU, and
a process of calculating a queuing margin in the ONU based on the queue length L, the report value R, and the allocation value G,
the congestion determination step determines the congestion in a case where the queuing margin is less than a congestion set value, and
the resolution determination step determines resolution of the congestion in a case where the queuing margin exceeds a resolution set value.

4. The automatic connection control method according to claim 2, wherein
the communication line is an Ethernet line including an L2SW,
the congestion calculation step includes
a process of acquiring a transmission capacity of the Ethernet line,
a process of acquiring a communication amount of the Ethernet line, and
a process of calculating a band utilization efficiency of the Ethernet line based on the transmission capacity and the communication amount,
the congestion determination step determines the congestion in a case where the band utilization efficiency exceeds a congestion set value, and
the resolution determination step determines resolution of the congestion in a case where the band utilization efficiency is lower than a resolution set value.

5. (canceled)

6. An automatic connection control system for controlling connection between a communication line connected to an upper network and a user terminal, the automatic connection control system comprising:
a router that establishes a connection to the user terminal in a wired or wireless manner; and
a communication control device that establishes communication between the communication line and the router, wherein
the communication control device includes a connection control notification unit that calculates a congestion degree of the communication line communicating with the upper network, determines congestion of the communication line and generates a disconnection notification in a case where the congestion degree exceeds a determination criterion, and generates a connection notification in a case where resolution of the congestion is recognized based on the congestion degree, and
the router includes
a network information storage unit that stores information indicating whether or not a user terminal being connected to the communication line has a function of establishing communication with another network different from the upper network,
a connection monitoring unit that monitors a connection state with the user terminal, and
a connection control unit that receives the disconnection notification and disconnects connection to the user terminal having a function of establishing communication with the another network among the user terminals being connected to the router, and receives the connection notification and enables reconnection to the user terminal of which connection has been disconnected after receiving the disconnection notification.

7. The automatic connection control system according to claim 6, wherein
the communication control device is an ONU,
the communication line is a PON including the ONU,
the ONU includes
a queue monitoring unit that monitors a queue length L of the ONU and acquires a report value R that indicates a data amount queued in the ONU, and
a Grant reception unit that acquires an allocation value G representing a data transmission amount allocated to the ONU, and
the connection control notification unit calculates a queuing margin in the ONU based on the queue length L, the report value R, and the allocation value G, determines the congestion in a case where the queuing margin is less than a congestion set value, and determines resolution of the congestion in a case where the queuing margin exceeds a resolution set value.

8. The automatic connection control system according to claim 6, wherein
the communication control device is an L2SW,
the communication line is an Ethernet line including the L2SW,
the L2SW includes
a band monitoring unit that monitors a transmission capacity and communication amount of the Ethernet line, and
the connection control notification unit calculates a band utilization efficiency of the Ethernet line based on the transmission capacity and the communication amount, determines the congestion in a case where the band utilization efficiency exceeds a congestion set value, and determines resolution of the congestion in a case where the band utilization efficiency is lower than a resolution set value.
